(19) United States
(12) Patent Application Publication
(10) Pub. No.: US 2015/0367752 A1
(43) Pub. Date: Dec. 24, 2015

(54) APPARATUS FOR MOVING MOTOR-OPERATED SEAT RAIL

(71) Applicant: Hyundai Dymos Incorporated, Chungcheongnam-do (KR)

(72) Inventors: Seung Hun Chang, Gyeonggi-do (KR); Jong Tak Lee, Gyeonggi-do (KR)

(21) Appl. No.: 14/745,007

(22) Filed: Jun. 19, 2015

(30) Foreign Application Priority Data
Jun. 20, 2014 (KR) 1020140075681

(51) Int. Cl. B60N 2/06; F16H 25/20

(52) U.S. Cl. CPC B60N 2/067; F16H 25/2003; F16H 25/2015

(57) ABSTRACT

An apparatus for moving a motor-operated seat rail, including a lead screw provided along an axial direction of a fixed rail, a mounting bracket having opposite ends combined with a moving rail, with the lead screw passing through a central portion of the mounting bracket so that the bracket moves along the lead screw, and a spindle nut engaged with the lead screw through a screw type engagement. A first end of the spindle nut is rotatably held on the mounting bracket so as to rotate relative to the bracket, and a second end passes through the central portion of the mounting bracket and extends along an axial direction of the lead screw, and being configured such that the inner diameter of the second end is able to be elastically reduced so that the inner circumferential surface of the second end comes into close contact with the outer circumferential surface of the lead screw.

### CROSS-REFERENCE TO RELATED APPLICATIONS

The present patent document claims the benefit of Korean Application Serial No. 10-2014-0075681, filed Jun. 20, 2014, the entirety of which is hereby incorporated by reference.

### FIELD

The present disclosure generally relates to an apparatus for moving a motor-operated seat rail.

### BACKGROUND

The statements in this section merely provide background information related to the present disclosure and may not constitute prior art.

Generally, a vehicle seat is installed in a vehicle such that the vehicle seat can slidably move forward and backward. To realize the forward and backward slide movement of the vehicle seat, a seat rail is provided.

The seat rail includes a fixed rail that is installed on a floor panel inside a passenger compartment, and a moving rail that is mounted to a seat cushion frame and is engaged with the fixed rail so as to axially move along the fixed rail.

In the related art, to move the moving rail forward and backward, two types of apparatuses have been proposed and are used: a hand-operated apparatus in which the moving rail is moved in response to a hand operation of a lever, and an electric apparatus in which the moving rail is moved by motor power applied from a motor in response to a simple manipulation on a button.

In the electric apparatus for moving the seat rail, a lead screw axially installed along the seat rail. In the related art, the lead screw is configured such that the lead screw directly receives motor power and rotates about an axial direction thereof, thereby moving the moving rail.

However, the conventional construction of the electric apparatus in which the lead screw directly rotates about the axial direction thereof is problematic in that the rotation of the lead screw generates vibration and noise caused by the vibration, thus reducing the comfort of passengers.

In an effort to solve the above-mentioned problems, an electric apparatus for moving a seat rail shown in FIG. 1 was proposed and used. As shown in FIG. 1, the apparatus includes a mounting bracket 2 combined with a moving rail, and a worm gear unit 3 provided on the mounting bracket 2, wherein a worm wheel gear of the worm gear unit 3 is engaged with the lead screw 1 in such a way that that the worm wheel gear can rotatably move along the lead screw 1. Further, a motor (not shown) is connected to the worm gear unit 3, so when the motor is operated, the lead screw 1 is not rotated, but the mounting bracket 2 combined with the moving rail axially moves along the lead screw 1, thereby moving the moving rail.

It has been discovered that to realize easy rotation of the apparatus shown in FIG. 1, backlash is formed between internal threads formed around the inner circumferential surface of the worm wheel gear and the external threads formed around the outer circumferential surface of the lead screw (e.g. first outer circumferential surface). Due to the backlash, the apparatus generates backlash noise and vibration during a movement of the seat rail.

The foregoing is intended merely to aid in the understanding of the background of the present disclosure, and is not intended to mean that the present disclosure falls within the purview of the related art that is already known to those skilled in the art.

### BRIEF SUMMARY

Accordingly, the present disclosure provides for a nut part being movably engaged with a lead screw and brought into elastic close contact with the outer circumferential surface of the lead screw. This arrangement reduces backlash noise and vibration during a movement of the motor-operated seat rail.

According to one aspect of the present disclosure, there is provided an apparatus for moving a motor-operated seat rail having a moving rail and a fixed rail extending along an axial direction, including a lead screw having an outer circumferential surface (e.g. a first outer circumferential surface); a mounting bracket, opposite ends of which may be adapted to be combined with a moving rail, with the lead screw passing through a central portion of the mounting bracket so that the mounting bracket moves along the lead screw; and a spindle nut engaged with the lead screw through a screw type engagement. A first end of the spindle nut may be rotatably held on the mounting bracket such that the first end of the spindle nut rotates relative to the mounting bracket. A second end of the spindle nut may pass through the central portion of the mounting bracket and extend along an axial direction of the lead screw. The second end may be configured such it has an inner circumferential surface (e.g. first inner circumferential surface) defining an inner diameter to be elastically reducible so that the first inner circumferential surface of the second end of the spindle nut comes into close contact with the first outer circumferential surface of the lead screw.

In the apparatus, elastic parts and slot parts may be alternately and radially formed in the second end of the spindle nut; and a push holder may be fitted over the spindle nut such that the push holder compresses outer circumferential surfaces of the elastic parts in respective radial directions toward an axis of the spindle nut, so the radially compressed elastic parts come into close contact with the first outer circumferential surface of the lead screw.

The push holder includes an inner circumferential surface (e.g. a second inner circumferential surface) and may be linearly movable along axial directions of the elastic parts, so when the push holder moves to ends of the elastic parts, the second inner circumferential surface of the push holder compresses respective protruding portions provided on the outer circumferential surfaces of the elastic parts, thereby compressing the elastic parts in the radial directions toward the axis of the spindle nut. An elastic spring may be provided between the push holder and the mounting bracket, so that the elastic spring elastically biases the push holder in a direction toward the second end of the spindle nut.

The outer circumferential surfaces of the ends of the elastic parts (e.g. second outer circumferential surfaces) may be provided with first inclined surfaces that gradually increase an outer diameter of the spindle nut; and second the inner circumferential surface of the push holder that comes into contact with the first inclined surfaces may be provided with a second inclined surface that gradually increases an inner diameter of the push holder such that the second inclined surface corresponds to the first inclined surfaces.

Further, a base holder may be fitted over the spindle nut such that the base holder abuts on an outer surface of the mounting bracket; and a support flange may protrude from an outer circumferential surface of the push holder (e.g. third outer circumferential surface), wherein spring opposite ends of the elastic spring may be stopped by the base holder and the support flange, respectively.

The mounting bracket may include opposite support parts bent downward at opposite ends thereof, with the lead screw passing through the opposite support parts; and a connection part connected to lower ends of the opposite support parts, wherein the first end of the spindle nut may be placed between the opposite support parts of the mounting bracket, with stop protrusions being provided on an outer circumferential surface of the first end of the spindle nut (e.g. fourth outer circumferential surface) at spaced locations such that the stop protrusions are held by respective inside surfaces of the opposite support parts, respectively.

The apparatus may further include a worm wheel gear provided between the stop protrusions; and a worm gear engaged with the worm wheel gear and rotated by torque applied from an external power source.

As described above, in the present disclosure, a spindle nut is engaged with a lead screw through screw type engagement, and the inner circumferential surface of an end of the spindle nut comes into elastic close contact with the outer circumferential surface of the lead screw, thereby reducing the axial clearance between internal threads formed around the inner circumferential surface of the spindle nut and external threads formed around the outer circumferential surface of the lead screw, and minimizing backlash noise and vibration generated from between the threads of the spindle nut and the lead screw during a forward and backward movement of a seat, and providing silent and comfortable environment in the passenger compartment.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

In order that the disclosure may be well understood, there will now be described various forms thereof, given by way of example, reference being made to the accompanying drawings, in which:

FIG. 1 is a view showing a conventional apparatus for moving a motor-operated seat rail;

FIG. 2 is a view showing the construction of an apparatus for moving a motor-operated seat rail according to the present disclosure;

FIG. 3 is an exploded view showing elements combined between a mounting bracket and a lead screw in the apparatus for moving the motor-operated seat rail according to the present disclosure;

FIG. 4 is a view showing a combination relationship between an elastic spring, a push holder, and elastic parts of the present disclosure; and

FIG. 5 is a view showing the construction and operational theory of pressing the elastic parts by the push holder of the present disclosure.

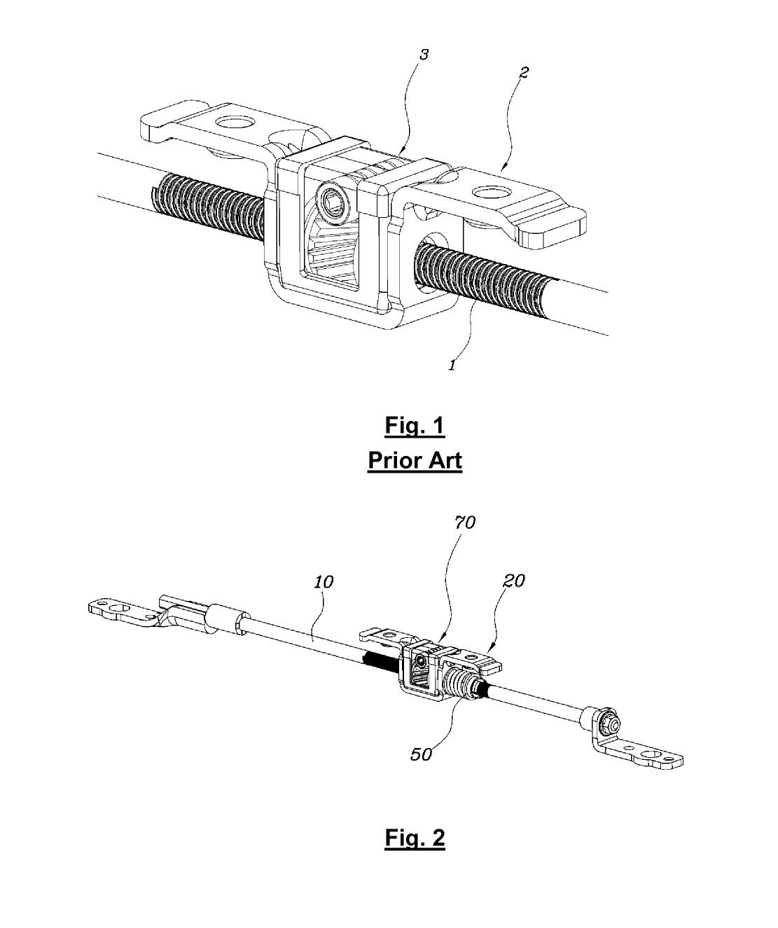

### DETAILED DESCRIPTION

The following description is merely exemplary in nature and is not intended to limit the present disclosure, application, or uses. It should be understood that throughout the drawings, corresponding reference numerals indicate like or corresponding parts and features. Hereinbelow, an exemplary embodiment of the present disclosure will be described in detail with reference to the accompanying drawings.

The apparatus for moving the motor-operated seat rail according to the present disclosure may include a lead screw 10, a mounting bracket 20, and a spindle nut 30.

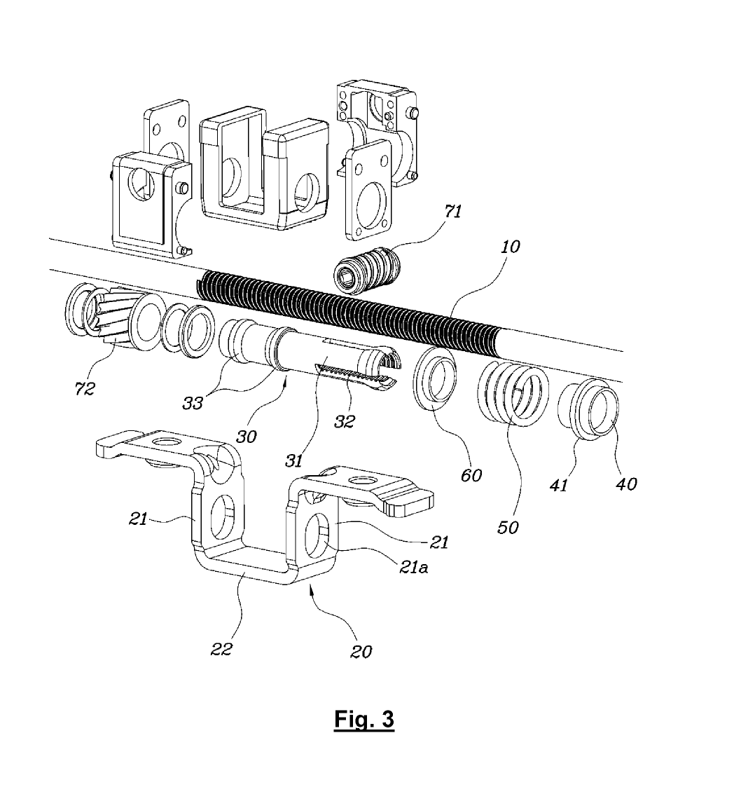

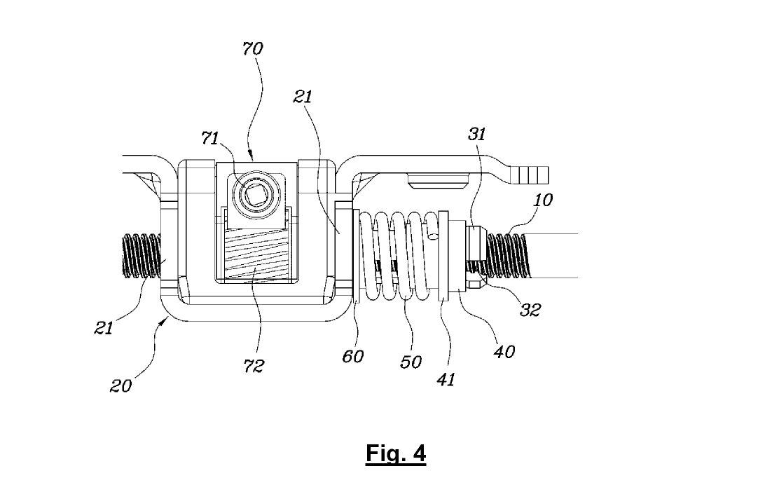

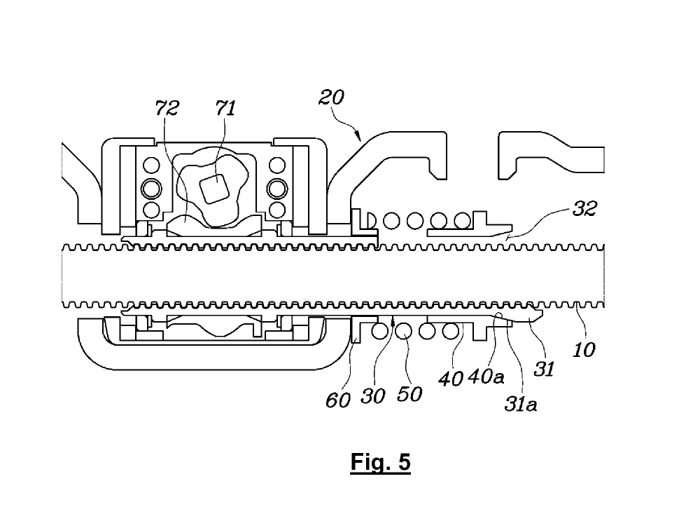

With reference to FIGS. 2 to 5, the apparatus for moving the motor-operated seat rail includes a lead screw 10 provided along an axial direction of a fixed rail; a mounting bracket 20, opposite ends of which are combined with a moving rail, with the lead screw 10 passing through a central portion of the mounting bracket 20 so that the mounting bracket 20 can move along the lead screw 10; and a spindle nut 30 engaged with the lead screw 10 through a screw type engagement, a first end of the spindle nut 30 being rotatably held on the mounting bracket 20 such that the first end of the spindle nut 30 can rotate relative to the mounting bracket 20, and a second end of the spindle nut 30 passing through the central portion of the mounting bracket 20 and extending along an axial direction of the lead screw 10, and being configured such that an inner diameter of the second end of the spindle nut 30 can be elastically reduced so that an inner circumferential surface of the second end of the spindle nut 30 (e.g. first inner circumferential surface) comes into close contact with an outer circumferential surface of the lead screw 10 (e.g. a first outer circumferential surface).

Here, opposite ends of the lead screw 10 may be mounted to the fixed rail, and the opposite ends of the mounting bracket 20 may be mounted to the moving rail. The configurations of the moving rail and the fixed rail are well known to those skilled in the art of the seat rail.

Further, the mounting bracket 20 has a U-shaped structure. The mounting bracket 20 may include opposite support parts 21 that are bent downward at opposite ends thereof and have respective through holes 21a so as to allow the lead screw to pass through the holes 21a; and a connection part 22 connected to lower ends of the opposite support parts 21, thereby connecting the opposite support parts 21 to each other.

Further, the first end of the spindle nut 30 is placed between the opposite support parts 21 of the mounting bracket 20, with stop protrusions 33 being provided on the outer circumferential surface of the first end of the spindle nut 30 at spaced locations such that the stop protrusions 33 are held by the inside surfaces of the opposite support parts 21, respectively.

Further, a worm wheel gear 72 is provided between the opposite stop protrusions 33. The worm wheel gear 72 is engaged with a worm gear 71. The worm gear 71 is connected to an external power source, for example, a motor, so the worm gear 71 is rotated by torque applied from the motor, and transmits the torque to the worm wheel gear 72. Here, the worm gear unit 70 may be configured in the form of a gear box structure provided between the opposite support parts 21 of the mounting bracket 20.

In other words, in one form of the apparatus of the present disclosure, the spindle nut 30 is engaged with the lead screw 10 through a screw type engagement and is configured such that, when the torque of the motor is transmitted to the spindle nut 30 via the worm gear unit 70 and the spindle nut 30 is rotated, the inner circumferential surface of the second end of the spindle nut 30 comes into elastic close contact with the outer circumferential surface of the lead screw 10. Thus, the present disclosure can reduce the axial clearance between the internal threads formed on the inner circumferential surface of the spindle nut 30 and the external threads formed on the outer circumferential surface of the lead screw 10.

Accordingly, the apparatus of the present disclosure can minimize backlash noise and vibration generated from between the threads of the spindle nut 30 and the lead screw 10 during a forward and backward movement of a seat, thereby providing silent and comfortable environment to the passenger compartment.

To provide a construction capable of bringing the inner circumferential surface of the second end of the spindle nut 30 into close contact with the outer circumferential surface of the lead screw 10, elastic parts 31 and slot parts 32 may be alternately and radially formed in the second end of the spindle nut 30 such that the elastic parts 31 and the slot parts 32 extend in axial directions of the spindle nut 30. Further, a push holder 40 is fitted over the second end of the spindle nut such that the push holder 40 compresses the outer circumferential surfaces of the elastic parts 31 (second outer circumferential surfaces) in radial directions toward the axis of the spindle nut 30, so the radially compressed elastic parts of the second end of the spindle nut 30 come into close contact with the outer circumferential surface of the lead screw 10.

In other words, the push holder 40 is fitted over the elastic parts 31 such that the inner circumferential surface of the push holder 40 (e.g. second inner circumferential surface) can radially compress the outer circumferential surfaces of the elastic parts 31. Thus, the elastic parts 31 move in radial directions toward the axis of the lead screw 10, and the inner diameter formed by the elastic parts 31 is reduced, so the inner circumferential surface of the spindle nut 30 can come into close contact with the outer circumferential surface of the lead screw 10.

Specifically, in the present disclosure, the push holder is configured to be linearly movable along the axial directions of the elastic parts 31, so when the push holder 40 moves to the ends of the elastic parts 31, the inner circumferential surface of the push holder 40 compresses protruding portions provided on the outer circumferential surfaces of the elastic parts 31, thereby compressing the elastic parts 31 in radial directions toward the axis of the spindle nut 30.

In the present disclosure, first inclined surfaces 31a are formed on the outer circumferential surfaces of the ends of the elastic parts 31 such that the first inclined surfaces 31a gradually increase the outer diameter of the spindle nut 30. To correspond to the shape of the first inclined surfaces 31a, the inner circumferential surface of the push holder 40 that comes into contact with the first inclined surfaces 31a is provided with a second inclined surface 40a that gradually increases the inner diameter of the push holder 40 in a direction toward the end of the push holder 40.

In other words, when the push holder 40 is moved toward the ends of the elastic parts 31, the second inclined surface 40a formed on the inner circumferential surface of the push holder 40 comes into contact with the first inclined surfaces 31a formed on the outer circumferential surfaces of the elastic parts 31, thereby compressing the outer circumferential surfaces of the elastic parts 31. Thus, the inner circumferential surfaces of the ends of the elastic parts 31 having the first inclined surfaces 31a come into close contact with the outer circumferential surface of the lead screw 10, thereby minimizing the axial clearance between the lead screw 10 and the elastic parts 31.

Further, in the present disclosure, an elastic spring 50 may be provided between the push holder 40 and the mounting bracket 20, so that the elastic spring 50 can elastically bias the push holder 40 in a direction toward the second end of the spindle nut 30.

Further, in the apparatus, a base holder 60 may be fitted over the spindle nut 30 such that the base holder 60 abuts on the outer surface outside a through hole 21a of the mounting bracket 20; and a support flange 41 may annularly protrude from the outer circumferential surface of the push holder 40 (e.g. third outer circumferential surface). Here, the opposite ends of the elastic spring 50 may be stopped by the base holder 60 and the support flange 41, respectively.

In other words, the elastic spring 50 may be installed between the base holder 60 and the push holder 40 such that the elastic spring 50 elastically biases the push holder 40, so the push holder 40 may be normally biased in a direction toward the ends of the elastic parts 31. Thus, the second inclined surface 40a of the push holder 40 can compress the first inclined surfaces 31a of the elastic parts 31 in radial directions toward the axis of the lead screw 20.

Although forms of the present disclosure has been described for illustrative purposes, those skilled in the art will appreciate that various modifications, additions and substitutions are possible, without departing from the scope and spirit of the disclosure as in the accompanying claims.

1. An apparatus for moving a motor-operated seat rail having a moving rail and a fixed rail extending along an axial direction, the apparatus comprising:
a lead screw having a first outer circumferential surface;
a mounting bracket having an outer surface and mounting opposite ends adapted to be combined with the moving rail, the lead screw passing through a central portion of the mounting bracket so that the mounting bracket moves along the lead screw; and
a spindle nut engaged with the lead screw through a screw engagement and having a first end and a second end, the first end being rotatably held on the mounting bracket such that the first end rotates relative to the mounting bracket, the second end passing through the central portion of the mounting bracket and extending along the axial direction, the second end having a first inner circumferential surface defining an inner diameter being elastically reducible so that the first inner circumferential surface comes into close contact with the first outer circumferential surface of the lead screw.

2. The apparatus according to claim 1, wherein the second end comprises a plurality of elastic parts having respective second outer circumferential surfaces and being alternately and radially formed with a plurality of slot parts.

3. The apparatus according to claim 2, further comprising a push holder fitted over the spindle nut such that the push holder compresses the second outer circumferential surfaces in respective radial directions toward an axis of the spindle nut, so that the elastic parts come into close contact with the first outer circumferential surface of the lead screw.

4. The apparatus according to claim 3, wherein the push holder includes a second inner circumferential surface and is linearly movable along the axial direction such that the second inner circumferential surface compresses the elastic parts at respective protruding portions provided on the second outer circumferential surfaces of the elastic parts to compress the elastic parts in the radial directions toward the axis of the spindle nut.

5. The apparatus according to claim 3 further comprising an elastic spring positioned between the push holder and the mounting bracket to elastically bias the push holder in a direction toward the second end of the spindle nut.

6. The apparatus according to claim 4, wherein the second outer circumferential surfaces of the ends of the elastic parts include respective first inclined surfaces that gradually increase an outer diameter of the spindle nut.

7. The apparatus according to claim 6, wherein the second inner circumferential surface of the push holder comprises a second inclined surface that gradually increases an inner diameter of the push holder such that the second inclined surface corresponds to the first inclined surfaces.

8. The apparatus according to claim 5, further comprising a base holder and a support flange, the base holder being fitted over the spindle nut such that the base holder abuts on the outer surface of the mounting bracket, the push holder having a third outer circumferential surface such that the support flange protrudes from the third outer circumferential surface, and wherein the elastic spring includes spring opposite ends being stopped by the base holder and the support flange, respectively.

9. The apparatus according to claim 1, wherein the mounting bracket includes a connection part and opposite support parts bent downward at the mounting opposite ends thereof and terminating in respective lower ends, the lead screw passing through the opposite support parts, the connection part connected to the lower ends wherein the first end of the spindle nut is disposed between the opposite support parts.

10. The apparatus according to claim 9, wherein the spindle nut comprises a fourth outer circumferential surface having stop protrusions being spaced apart from each other at the first end such that the stop protrusions are engageable by the opposite support parts at their respective inside surfaces.

11. The apparatus according to claim 10, further comprising a worm wheel gear positioned between the stop protrusions and a worm gear engaged with the worm wheel gear and rotated by torque applied from an external power source.
